(19) United States
(12) Patent Application Publication
(10) Pub. No.: US 2018/0370185 A1
(43) Pub. Date: Dec. 27, 2018

(54) Sandwich Panel

(71) Applicant: Ten Cate Advanced Composites B.V., Nijverdal (NL)

(72) Inventor: John Allan Darlington, Nijverdal (NL)

(73) Assignee: Ten Cate Advanced Composites B.V, Nijverdal (NL)

(21) Appl. No.: 16/015,239

(22) Filed: Jun. 22, 2018

Related U.S. Application Data
(60) Provisional application No. 62/523,376, filed on Jun. 22, 2017.

(51) Int. Cl. B32B 7/10; B32B 37/18; B32B 27/12; B32B 27/08

(52) U.S. Cl. CPC B32B 7/10; B32B 37/182; B32B 27/12; B32B 2250/40; B32B 2262/101; B32B 2262/106; B32B 27/08

(57) ABSTRACT

A face sheet comprising a first layer and a second layer secured together. The first layer comprising a thermoplastic material and the second layer comprising a thermoset material.

### FIELD OF INVENTION

The present invention relates to a sandwich panel comprising a core and multi-layer face sheets, particularly for use in the aerospace industry.

### BACKGROUND

Sandwich panels are used extensively in the aerospace industry as interior components where high strength yet lightweight materials are desired. In this manner, sandwich panels also have to comply with fire performance requirements. Sandwich panels refer to a structure where face sheets are adhered to opposing surfaces of a core. The face sheets are typically manufactured from a prepreg, which is a fiber reinforced fabric that has been preimpregnated with a thermoset or thermoplastic resin. Although thermosets, such as phenolic thermosets, have good fire performance they have relatively poor mechanical performance once cured. Epoxy thermosets, on the other hand, have good mechanical performance but curing negatively affects their fire performance. Thermoplastics, by contrast, require a separate adhesive layer to adhere to a core which can contribute to the weight of the sandwich panel.

### SUMMARY

According to a first aspect of the present invention, a face sheet comprises a first layer and a second layer. The first layer comprises a thermoplastic material and the second layer comprises a thermoset material. The first layer and the second layer may be secured together. Securing the first layer and the second layer forms a multi-layer face sheet having the advantageous properties of each layer. Specifically, the first layer meets the FAA Fire, Smoke, Toxicity (FST) and OSU Heat Release requirements and is strong, durable and moisture and solvent resistant. The second layer is strong, durable, self-adhesive and lightweight. Securing the first layer and the second layer further forms a multi-layer face sheet that is free from intracell bucking or dimpling.

In an embodiment, the first layer may be pre-impregnated with a thermoplastic resin such as polyetherimide. Polyetherimide meets the FAA Fire, Smoke, Toxicity (FST) and OSU Heat Release requirements and is strong, durable and moisture and solvent resistant.

In an embodiment, the second layer may be pre-impregnated with a thermoset resin such as epoxy. Epoxy is strong, durable, self-adhesive and lightweight.

In an embodiment, at least one of the first layer and the second layer further comprises reinforcing fibers such as glass fibers and/or carbon fibers. The reinforcing fibers can provide extra strength and rigidity.

In an embodiment, the first layer and the second layer may be secured together by a bonding process. The bonding process can be, for example, oven curing. The bonding process facilitates crosslinking between the first layer and the second layer, thereby ensuring a stable and secure face sheet despite being multi-layered.

According to second aspect of the present invention, a sandwich panel comprises two face sheets and a core disposed between the two face sheets. Each of the face sheets comprises a first layer and a second layer. The first layer comprises a thermoplastic resin. The second layer comprises a thermoset resin. The first layer and the second layer may be secured together. Securing the first layer and the second layer forms a multi-layer face sheet having the advantageous properties of each layer. Specifically, the first layer meets the FAA Fire, Smoke, Toxicity (FST) and OSU Heat Release requirements and is strong, durable and moisture and solvent resistant. The second layer is strong, durable, self-adhesive and lightweight. Securing the first layer and the second layer further forms a multi-layer face sheet that is free from intracell bucking or dimpling.

In an embodiment, the core may be a honeycomb core or a foam core. This type of core can adhere to the second layer and ensures a lightweight sandwich panel.

In an embodiment, the thermoplastic resin may be polyetherimide and the thermoset resin may be epoxy. Polyetherimide meets the FAA Fire, Smoke, Toxicity (FST) and OSU Heat Release requirements and is strong, durable and moisture and solvent resistant. Epoxy is strong, durable, self-adhesive and lightweight.

In an embodiment, at least one of the first layer and the second layer further comprises reinforcing fibers such as glass and/or carbon fibers. The reinforcing fibers can provide extra strength and rigidity.

In an embodiment, the first layer is non-symmetrical. A non-symmetrical construction could provide high wear resistance, high impact requirements and/or act as a barrier layer to at least one side of the sandwich panel. A non-symmetrical construction could also result in further weight and cost savings.

In an embodiment, the first layer and the second layer may be secured together through a bonding process. The bonding process facilitates crosslinking between the first layer and the second layer, thereby ensuring a stable and secure face sheet despite being multi-layered.

In an embodiment, each of the face sheets may be bonded to an opposing surface of the core. In this manner, each face sheet is self-adhesive such that a separate adhesive layer is not required to adhere each face sheet to an opposing surface of the core.

In an embodiment, the sandwich panel may be cured. Curing facilitates bonding of the face sheets to opposing surfaces of the core.

In a third aspect of the invention, a method of manufacturing a face sheet, comprises providing two face sheets wherein each of the face sheets comprises a first layer and a second layer and wherein the first layer and the second layer are bonded.

In an embodiment, during bonding the first layer is inert and the second layer crosslinks and bonds to the first layer.

These are various other features and advantages will be apparent from a reading of the following detailed description.

### BRIEF DESCRIPTION OF THE DRAWINGS

FIG. 1 illustrates an exploded view of a sandwich panel according to the prior art.

FIG. 2 illustrates an exploded view of a sandwich panel according to the present invention.

FIG. 3 illustrates a cross-sectional exploded view of a sandwich panel with a non-symmetrical construction according to the present invention.

FIG. 4 illustrates a top perspective view of a sandwich panel according to the present invention.

FIG. 5 illustrates a schematic of a method for manufacturing a face sheet.

### DETAILED DESCRIPTION

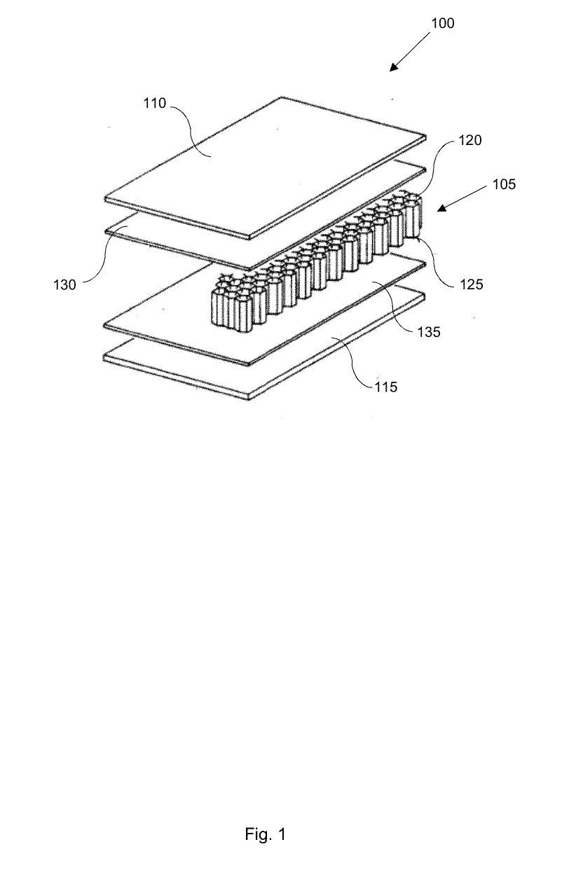

FIG. 1 illustrates an embodiment of a sandwich panel according to the prior art. As shown in FIG. 1, the sandwich panel 100 comprises a honeycomb core 105 disposed between two face sheets 110, 115. Each face sheet 110, 115 is adhered to opposing surfaces 120, 125 of the honeycomb core 105 by an adhesive layer 130, 135.

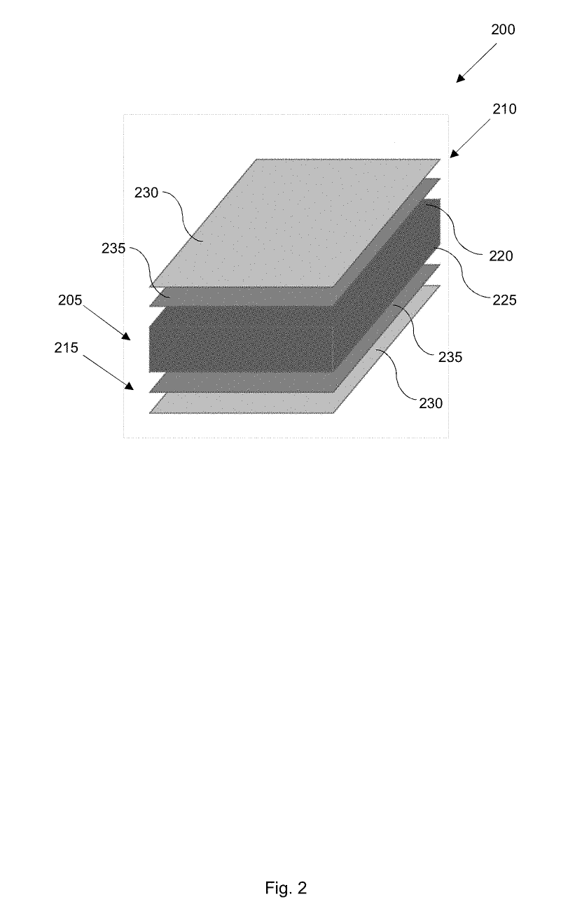

FIG. 2 illustrates an exploded view of a sandwich panel according to the present invention. As shown in FIG. 2, the sandwich panel 200 comprises a core 205 disposed between two face sheets 210, 215. Each face sheet 210, 215 is self-adhesive such that each face sheet 210, 215 is adhered to an opposing surface 220, 225 of the core 205 without a separate adhesive layer. FIG. 2 also shows a symmetrical construction in which the first layer 230 adhered to surface 220 is the same thickness as the first layer 230 adhered to surface 225. The core 205 may be a number of different varieties of cores, such as, but not limited to, a honeycomb, foam or balsa wood core.

The face sheets 210, 215 include a first layer 230 and a second layer 235. However, the face sheets 210, 215 may also comprise additional layers, such as a decorative layer, a strengthening layer or other layer(s) depending on the intended application and requirements of the sandwich panel. The thickness of each layer 230, 235 can vary, for example, between about 0.2 mm and about 0.5 mm. The thickness of each layer 230, 235 can also vary, in part, due to the fiber reinforcement. The fiber reinforcement of each layer 230, 235 can be at least 100 grams per m².

The first layer 230 is pre-impregnated with thermoplastic resin and reinforced with fibers. The first layer meets the FAA Fire, Smoke, Toxicity (FST) and OSU Heat Release requirements and is strong, durable and moisture and solvent resistant. The resin may be chosen from the group comprising polyetherimide (PEI), polyphenylene sulfide (PPS), polyethersulfone (PESU), polycarbonate (PC), polyether ether ketone (PEEK), polyaryl ether ketone (PAEK), and mixtures thereof. The tensile strength of the neat resin is about 50 MPa to about 150 MPa (according to UL94 ISO R527) and the tensile modulus is about 2,000 MPa to about 3,500 MPa (according to ISO R527). The compression strength of the neat resin is about 75 MPa to about 150 MPa and the compression modulus is about 2,000 MPa to about 3,500 MPa (according to ASTM D695). The moisture absorption of the neat resin is about 0% to about 5% (according to ISO 62). The fibers may be chosen from the group comprising glass, carbon, aramid, polyester and mixtures thereof, though different types and/or combinations of fibers may be present in different embodiments. In an exemplary embodiment, the first layer 230 is pre-impregnated with PEI resin and reinforced with glass and/or carbon fibers. The neat resin content by volume may be about 25% to about 75%. The neat resin content by weight may be about 15% to about 50%.

The second layer 235 is pre-impregnated with thermoset resin and reinforced with fibers. The second layer is strong, durable, self-adhesive and lightweight. The resin may be chosen from the group of resins comprising epoxy, polyester, vinyl ester, polyurethane, phenolic, bismaleimide and mixtures thereof. The tensile strength of the resin is about 50 MPa to about 100 MPa (according to UL94 ISO R527) and the tensile modulus is about 1 GPa to about 5 GPa (according to ISO R527). The compression strength of the resin is about 90 MPa to about 150 MPa and the compression modulus is about 1 GPa to about 5 GPa (according to ASTM D695). The fibers may be chosen from the group comprising glass, carbon, aramid, polyester and mixtures thereof, though different types and/or combinations of fibers may be present in different embodiments. In an exemplary embodiment, the second layer 235 is pre-impregnated with epoxy resin and reinforced with glass and/or carbon fibers. The neat resin content by volume may be about 40% to about 60%. The neat resin content by weight may be about 30% to about 50%.

The first layer 230 and the second layer 235 are secured together to form a multi-layer face sheet 210, 215. The first layer 230 and the second layer 235 may be secured together by a bonding process, for example, oven curing. During the bonding process, the second layer (being pre-impregnated with thermoset resin) 235 crosslinks and bonds to the first layer (being impregnated with thermoplastic resin) 230 by placing the layers 230, 235 under controlled temperature and pressure conditions for a sufficient amount of time. In an exemplary embodiment, the layers 230, 235 may be heated about 1° C. to about 3° C. per minute until they reach a temperature between about 80° C. to about 200° C. The temperature may remain constant for at least 60 minutes. Then the layers 230, 235 may be cooled to at least 71° C. at which point the pressure is released and the bonding process is complete. The first layer 230 remains inert during the bonding process enabling a non-symmetrical construction of the sandwich panel 200. The first layer 230 and the second layer 235 may be secured together anytime during the manufacturing of the sandwich panel 200.

By securing the first layer 230 and the second layer 235 through a bonding process, a multi-layer face sheet 210, 215, and thus a sandwich panel 200, is formed having the advantageous properties of each layer 230, 235. Specifically, the first layer 230 meets the FAA Fire, Smoke,

Toxicity (FST) and OSU Heat Release requirements and is strong, durable and moisture and solvent resistant. The second layer 235 is strong, durable, self-adhesive and lightweight. Securing the first layer 230 and the second layer 235 further forms a multi-layer face sheet 200 that is free from intracell bucking or dimpling.

The first layer 230 provides a barrier for the second layer 235, protecting it and its performance properties. Because of its properties such a sandwich panel 200 is suitable for a wide variety of applications such as, but not limited to, components of aircraft, cars, trains, trucks, boats and space vehicles. The sandwich panel 200 may be especially useful for interior components of an aircraft such as storage bins, service carts, ducting, seat structures, flooring, galleys and ceiling, cabin and cargo linings due to its strength and durability while remaining lightweight.

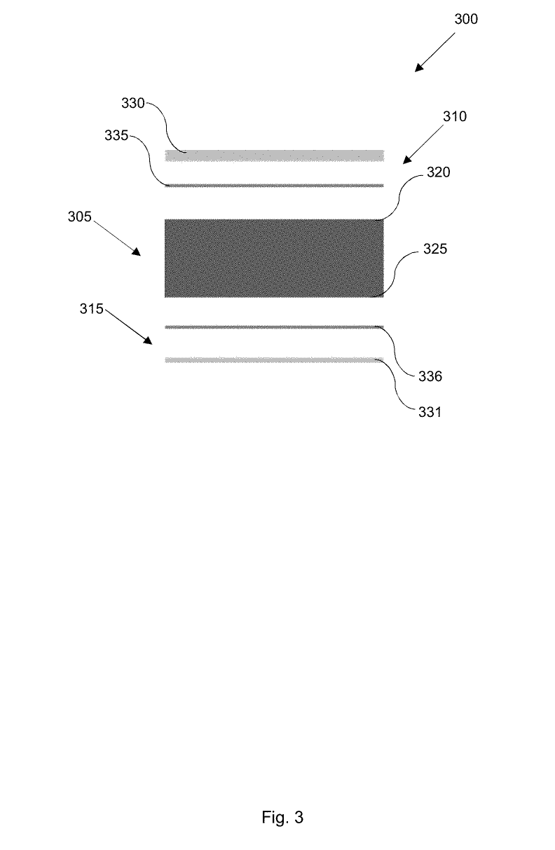

FIG. 3 illustrates a cross-sectional exploded view of a sandwich panel with a non-symmetrical construction according to the present invention. As shown in FIG. 3, the sandwich panel 300 comprises a core 305 disposed between two face sheets 310, 315. Each face sheet 310, 315 comprises a first layer 330, 331 and a second layer 335, 336 adhered to an opposing surface 320, 325 of the core 305 without a separate adhesive layer. FIG. 3 also shows a non-symmetrical construction in which the thickness of the first layers 330, 331 can vary, in part, due to the fiber reinforcement. Specifically, at least one of the first layers 330,331 may comprise one or more layers of fiber reinforcement. In an exemplary embodiment, layer 330 may comprise seven layers of fiber reinforcement and layer 331 may comprise three layers of fiber reinforcement such that layer 330 is thicker than layer 331. A non-symmetrical construction depends on the intended application and requirements of the sandwich panel 300. A non-symmetrical construction could provide high wear resistance, high impact requirements and/or act as a barrier layer to at least one side of the sandwich panel 300. A non-symmetrical construction could also result in further weight and cost savings in being able to include only the necessary layers of fiber reinforcement.

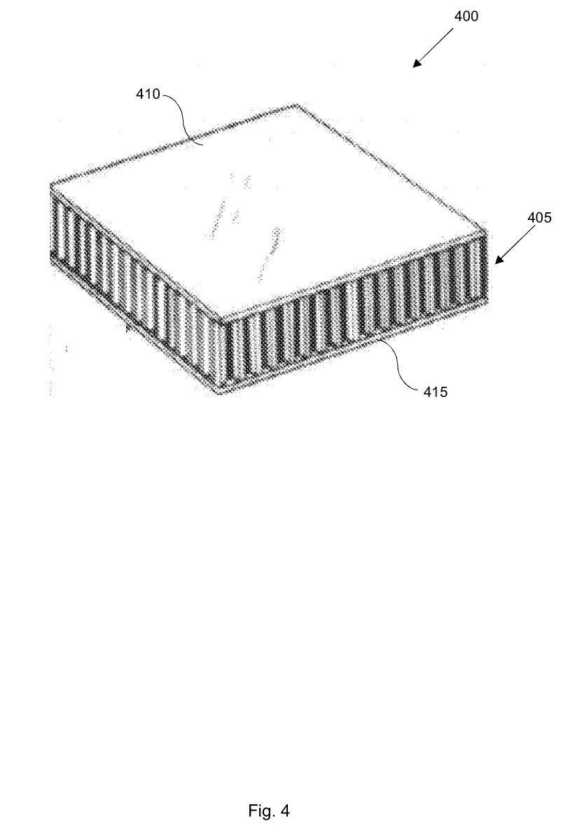

FIG. 4 illustrates a top perspective view of a sandwich panel according to the present invention. As shown in FIG. 4, the sandwich panel 400 comprises a core 405 disposed between two face sheets 410, 415. Each face sheet 410, 415 is adhered to an opposing surface of the core 405 without a separate adhesive layer. In this manner, face sheet 410 may be adhered to a top surface of the core 405 and face sheet 415 may be adhered to a bottom surface of the core 405. The face sheets 410, 415 may be adhered to the core 405 by a similar bonding process to that discussed in relation to FIG. 2. During the bonding process, the second layer of the face sheet 410, 415 crosslinks and bonds to both the first layer of the face sheet 410, 415 and the core 405 under controlled temperature and pressure conditions for a sufficient amount of time to form sandwich panel 400. In an exemplary embodiment, the layers may be heated about 1° C. to about 3° C. per minute until they reach a temperature between about 80° C. to about 200° C. The temperature may remain constant for at least 60 minutes. Then the layers may be cooled to at least 71° C. at which point the pressure is released and the bonding process is complete. The first layer remains inert during the bonding process enabling a non-symmetrical construction of the sandwich panel 400 and the second layer is self-adhesive to opposing surfaces of the core 405 such that use of a separate adhesive layer is not required.

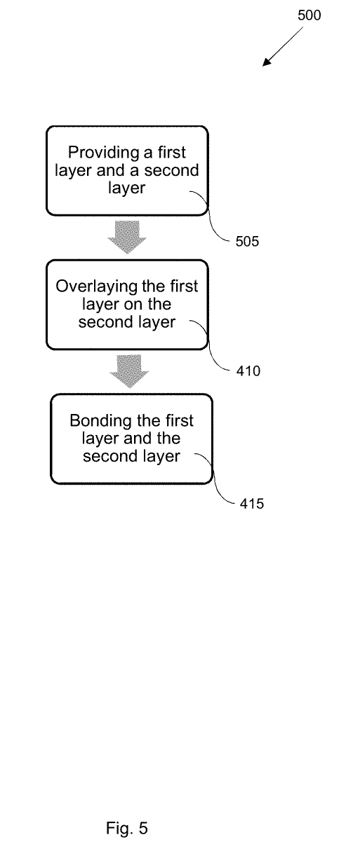

FIG. 5 illustrates a schematic of a method for manufacturing a face sheet. As shown in FIG. 5, the method 500 of manufacturing a face sheet comprises providing a first layer and a second layer 505. The method 500 then comprises overlaying the first layer on the second layer 510. Under controlled temperature and pressure conditions, the layers are bonded (i.e., cured) to form a face sheet 515. During the bonding process, the second layer of the face sheet crosslinks and bonds to the first layer. As one skilled in the art will recognize, the present invention could undergo various types of techniques designed to bond the layers together.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular or preferred embodiments disclosed, but that the invention will include all embodiments falling within the scope of the appended claims.

1. A face sheet, comprising:
a first layer comprising a thermoplastic material; and
a second layer comprising a thermoset material;
wherein said first layer and said second layer are secured together.

2. The face sheet according to claim 1, wherein said first layer is pre-impregnated with a thermoplastic resin.

3. The face sheet according to claim 2, wherein said thermoplastic resin is selected from the group consisting of polyetherimide, polyphenylene sulfide, polyethersulfone, polycarbonate, polyether ether ketone or polyaryl ether ketone.

4. The face sheet according to claim 1, wherein said second layer is pre-impregnated with a thermoset resin.

5. The face sheet according to claim 4, wherein said thermoset resin is selected from the group consisting of epoxy, polyester, vinyl ester, polyurethane, phenolic or bismaleimide.

6. The face sheet according to claim 1, wherein at least one of said first layer and said second layer further comprises reinforcing fibers.

7. The face sheet according to claim 6, wherein said reinforcing fibers comprise glass fibers and/or carbon fibers.

8. The face sheet according to claim 1, wherein said first layer and said second layer are secured together through a bonding process.

9. A sandwich panel, comprising:
two face sheets; and
a core disposed between said two face sheets;
wherein each of said face sheets comprises:
a first layer comprising a thermoplastic resin; and
a second layer comprising a thermoset resin;
wherein said first layer and said second layer are secured together.

10. The sandwich panel according to claim 9, wherein said core is a honeycomb core or a foam core.

11. The sandwich panel according to claim 9, wherein said thermoplastic resin is selected from the group consisting of polyetherimide, polyphenylene sulfide, polyethersulfone, polycarbonate, polyether ether ketone or polyaryl ether ketone.

12. The sandwich panel according to claim 9, wherein said thermoset resin is selected from the group consisting of epoxy, polyester, vinyl ester, polyurethane, phenolic or bismaleimide.

13. The sandwich panel according to claim 9, wherein at least one of said first layer and said second layer further comprise reinforcing fibers.

14. The sandwich panel according to claim 13, wherein said reinforcing fibers comprise glass fibers and/or carbon fibers.

15. The sandwich panel according to claim 13, wherein said first layer is non-symmetrical.

16. The sandwich panel according to claim 9, wherein said first layer and said second layer are secured together through a bonding process.

17. The sandwich panel according to claim 9, wherein each of said face sheets is bonded to an opposing surface of said core.

18. The sandwich panel according to claim 9, wherein said sandwich panel is cured.

19. A method of manufacturing a face sheet comprising:
providing two face sheets, wherein each of said face sheets comprises a first layer and a second layer; and
bonding said first layer and said second layer.

20. The method of manufacturing a face sheet according to claim 19, wherein during said bonding said first layer is inert and said second layer crosslinks and bonds to said first layer.
